(19) United States
(12) Patent Application Publication
(10) Pub. No.: US 2020/0027149 A1
(43) Pub. Date: Jan. 23, 2020

(54) PREDICTIVE PRODUCT ORDER RECOMMENDATIONS BASED ON A WEATHER EVENT FORECAST

(71) Applicant: INTERNATIONAL BUSINESS MACHINES CORPORATION, Armonk, NY (US)

(72) Inventor: Jeremy R. Fox, Georgetown, TX (US)

(21) Appl. No.: 16/038,445

(22) Filed: Jul. 18, 2018

(51) Int. Cl. G06Q 30/06; G06Q 30/02

(52) U.S. Cl. CPC G06Q 30/0631; G06Q 30/0205; G06Q 30/0201; G06Q 30/0641

(57) ABSTRACT

An approach is provided for sending a notification of recommended product(s) to purchase in preparation for a weather event. A location of a user is determined. A weather event is forecasted to affect location(s). Products for the weather event that are purchased by other users in the location(s) are determined. The products are purchased during a time period prior to the weather event. Based on the location of the user being included in the location(s) and the products purchased by the other users, product(s) are identified that were more popular to purchase by the other users during the time period than any other product purchased by the other users during the time period. A notification is sent to the user that recommends that the user purchase the identified product(s) to prepare for the weather event.

### BACKGROUND

The present invention relates to sending notifications, and more particularly to generating and sending recommendations about products to purchase based on a forecasted weather event.

Known weather data services display current weather conditions and historical and forecasted weather data for an area that is specified by a geolocation. The weather data is captured for all forms of weather, including precipitation, barometric pressure, wind, and thunderstorms. The forecasted weather data can include an hourly weather forecast, a daily forecast including narrative text, or a daily forecast broken into morning, afternoon, evening, and overnight segments. Conventional techniques of retrieving the weather data include using web service Application Programming Interfaces (APIs) that adhere to the Representational State Transfer (REST) architectural constraints. Known weather data services also provide weather alerts, where each alert describes details about a forecasted weather event for a given geographic area.

### SUMMARY

In one embodiment, the present invention provides a method of sending a notification of one or more recommended products to purchase in preparation for a weather event. The method includes a computer determining a location of a user in response to a determination that the user is utilizing an online portal for a shopping website. The method further includes the computer determining that a weather event is forecasted to affect one or more locations. The method further includes the computer determining that the location of the user is included in the one or more locations which are forecasted to be affected by the weather event. The method further includes the computer determining products purchased by other users in preparation for the weather event. The other users are located in the one or more locations. The products are purchased during a predetermined time period prior to the weather event. The method further includes based on the location of the user being included in the one or more locations forecasted to be affected by the weather event and the products purchased by the other users in preparation for the weather event, the computer identifying one or more products that were more popular to purchase by the other users during the predetermined time period than any other product purchased by the other users during the predetermined time period. The method further includes the computer sending a notification to the user via the online portal that recommends that the user purchase the identified one or more products to prepare for the weather event.

In another embodiment, the present invention provides a computer program product for sending a notification of one or more recommended products to purchase in preparation for a weather event. The computer program product includes a computer readable storage medium. Computer readable program code is stored in the computer readable storage medium. The computer readable storage medium is not a transitory signal per se. The computer readable program code is executed by a central processing unit (CPU) of a computer system to cause the computer system to perform a method. The method includes the computer system determining a location of a user in response to a determination that the user is utilizing an online portal for a shopping website. The method further includes the computer system determining that a weather event is forecasted to affect one or more locations. The method further includes the computer system determining that the location of the user is included in the one or more locations which are forecasted to be affected by the weather event. The method further includes the computer system determining products purchased by other users in preparation for the weather event. The other users are located in the one or more locations. The products are purchased during a predetermined time period prior to the weather event. The method further includes based on the location of the user being included in the one or more locations forecasted to be affected by the weather event and the products purchased by the other users in preparation for the weather event, the computer system identifying one or more products that were more popular to purchase by the other users during the predetermined time period than any other product purchased by the other users during the predetermined time period. The method further includes the computer system sending a notification to the user via the online portal that recommends that the user purchase the identified one or more products to prepare for the weather event.

In another embodiment, the present invention provides a computer system including a central processing unit (CPU); a memory coupled to the CPU; and a computer readable storage device coupled to the CPU. The storage device includes instructions that are executed by the CPU via the memory to implement a method of sending a notification of one or more recommended products to purchase in preparation for a weather event. The method includes the computer system determining a location of a user in response to a determination that the user is utilizing an online portal for a shopping website. The method further includes the computer system determining that a weather event is forecasted to affect one or more locations. The method further includes the computer system determining that the location of the user is included in the one or more locations which are forecasted to be affected by the weather event. The method further includes the computer system determining products purchased by other users in preparation for the weather event. The other users are located in the one or more locations. The products are purchased during a predetermined time period prior to the weather event. The method further includes based on the location of the user being included in the one or more locations forecasted to be affected by the weather event and the products purchased by the other users in preparation for the weather event, the computer system identifying one or more products that were more popular to purchase by the other users during the predetermined time period than any other product purchased by the other users during the predetermined time period. The method further includes the computer system sending a notification to the user via the online portal that recommends that the user purchase the identified one or more products to prepare for the weather event.

### BRIEF DESCRIPTION OF THE DRAWINGS

FIG. 1 is a block diagram of a system for sending a notification of one or more recommended products to purchase in preparation for a weather event, in accordance with embodiments of the present invention.

FIGS. 2A-2B depict a flowchart of a process of sending a notification of one or more recommended products to purchase in preparation for a weather event, where the process is implemented in the system of FIG. 1, in accordance with embodiments of the present invention.

FIG. 3 is an example of a notification of recommended products to purchase in preparation for a hurricane, where the notification is sent in the process of FIGS. 2A-2B, in accordance with embodiments of the present invention.

FIG. 4 is a block diagram of a computer included in the system of FIG. 1 and that implements the process of FIGS. 2A-2B, in accordance with embodiments of the present invention.

### DETAILED DESCRIPTION

### Overview

People need to prepare for weather events by purchasing particular products, but in conventional preparation approaches, some of the people do not know what products to purchase. Further, because some of the people preparing for a weather event do not know when to purchase the needed products, the conventional approach may include waiting too long to attempt to make a purchase and thereby encountering high demand products being sold out at nearby stores. For example, a person who has never experienced a hurricane may not understand what products to purchase or realize the need to purchase the products days in advance of the hurricane reaching the person's area in order to avoid the products being sold out at local stores. Still further, web-based businesses conventionally use only local knowledge and experience based on past weather events to drive selling decisions, thereby neglecting to account for the most current purchasing data, which includes purchases already made in preparation for the impending weather event.

Embodiments of the present invention address the aforementioned challenges of the conventional purchasing and selling decisions and selling decisions to push critical products to prepare people for an impending weather event several days prior to the occurrence of the weather event by combining weather forecasting data, crowdsourced product purchase data, and location-based awareness to provide people with product purchase recommendations days prior to a weather event. Embodiments of the present invention provide a predictive modeling component for web-based businesses to push critical products to consumers who are preparing for a forecasted weather event and/or re-distribute the critical products among physical stores to prevent or delay the products being sold out at particular stores prior to a weather event.

In one or more embodiments, crowdsourced data based on local ZIP codes or postal codes (or other geographic location) is used to determine products that people are actually purchasing prior to a particular weather event which is forecasted to affect a geographic location of the purchasers (i.e., determining the products that people are purchasing in preparation for the impending weather event). In one or more embodiments, the crowdsourced data is used to generate and send a notification to a user that includes an accurate recommendation, specific to the user's geographic location, for what products the user should purchase to prepare for the weather event and when the user should make the purchases.

### System For Sending a Notification of Recommended Product(s) to Purchase in Preparation For a Weather Event

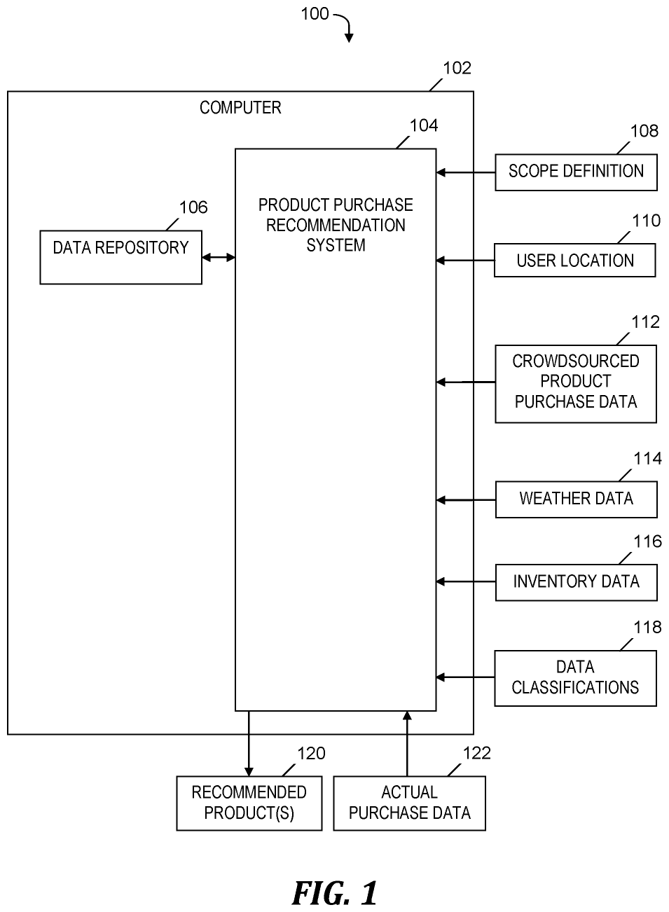

FIG. 1 is a block diagram of a system 100 for sending a notification of one or more recommended products to purchase in preparation for a weather event, in accordance with embodiments of the present invention. System 100 includes a computer 102, which executes a software-based product purchase recommendation system 104, and which includes a data repository 106 which stores a corpus of knowledge database (not shown).

Product purchase recommendation system 104 receives, retrieves, or determines a scope definition 108, a user location 110, crowdsourced product purchase data 112, weather data 114, inventory data 116, and data classifications 118.

In one embodiment, scope definition 108 includes identifiers of businesses whose websites provide data about products purchased by users utilizing online portals of the websites. In one embodiment, scope definition 108 specifies a particular time period that precedes a forecasted start of an impending weather event. Product purchase recommendation system 104 tracks and stores purchases of products made during the specified time period.

In one embodiment, scope definition 108 specifies a geographic location of a forecasted weather event, where the geographic location can be static or dynamic based on forecasts of a location of the weather event that changes over time. For example, the geographic location of a hurricane may change according to how a projected path of a hurricane changes over time. In one embodiment, scope definition 108 specifies the geographic location as an area corresponding to a single ZIP code or postal code.

In one embodiment, scope definition 108 specifies a scope of the weather event, including a type of a weather event (e.g., hurricane, flooding, high winds, extreme heat, extreme cold, etc.), a projected severity of the weather event, and a projected duration of the weather event.

User location 110 specifies a geographic location of a user, such as the latitude and longitude at which the user is located, or the ZIP code or postal code in which the user is located. In one embodiment, product purchase recommendation system 104 receives user location 110 from a website of one of the businesses identified in scope definition 108, in response to the user utilizing the online portal of the website to shop for products and allowing the portal to use the current location of the user.

Crowdsourced product purchase data 112 includes data specifying (i) products purchased by other users of the online portals of the businesses identified in scope definition 108, (ii) timestamps indicating dates and times at which the products were purchased, and (iii) the geographic locations (e.g., latitude and longitude) in which the other users were located at the time of the purchases of the products. In one embodiment, product purchase recommendation system 104 filters the products purchased to include only the products that were purchased (i) within the time period specified in scope definition 108 (i.e., in preparation for the weather event whose scope is specified in scope definition 108) and (ii) by users who were located in a geographic location (e.g., ZIP code or postal code) at the time of the respective purchases, where the geographic location of each user matches a forecasted geographic location of the weather event specified in scope definition 108.

Weather data 114 specifies a forecasted weather event, along with its type of weather event, forecasted date(s) and time(s) at which the weather event will start affecting particular geographic location(s), the forecasted level(s) of severity of the weather event at the geographic location(s), and the forecasted duration(s) of the weather event at the geographic location(s). In one embodiment, product purchase recommendation system 104 retrieves weather data 114 from a weather forecasting data service via an API.

Inventory data 114 specifies inventories of products that are available to purchase via an online portal of a shopping website and/or in physical venue(s) for the each of the businesses specified in scope definition 108.

In one embodiment, product purchase recommendation system 104 stores scope definition 108, user location 110, crowdsourced product purchase data 112, weather data 114, and inventory data 116 in the corpus of knowledge database included in data repository 106.

In one embodiment, data classifications 118 include contextual metadata, including names of weather events (e.g., Hurricane Harvey), event tagging to classify data pertaining to weather events and associated consumer products, and event filtering that specifies data related to a particular type of weather event.

In response to a determination that a user is using an online portal of one of the businesses specified in scope definition 108, product purchase recommendation system 104 uses inventory data 116, user location 110, weather data 114, and crowdsourced product purchase data 112 to determine the most popular products purchased by other users in the time period specified in scope definition 108, which indicates a likelihood that the products were purchased in preparation for the forecasted weather event indicated by weather data 114.

In one embodiment, product purchase recommendation system 104 selects the most popular products from the most popular products purchased by other users whose geographic locations match user location 110.

In another embodiment, product purchase recommendation system 104 selects a first group of most popular products from the most popular products purchased by a first group of other users whose geographic locations match user location 110 and also selects a second group of most popular products, which is different from the first group, and which is selected from the most popular products purchased by a second group of other users whose geographic locations do not match user location 110. In one embodiment, product purchase recommendation system 104 presents the first and second groups of most popular products using display attributes that indicate that the recommendation for purchasing the products in the first group has priority over the recommendation for purchasing the products in the second group. In one embodiment, the second group of users made the purchases of the products in the second group in preparation for one or more other weather events whose type matches the type of the weather event forecasted to affect the geographic location of the user.

Product purchase recommendation system 104 sends a notification to the user via the online portal of the website, where the notification includes details about recommended product(s) 120 (i.e., product(s) that are recommended to be purchased to prepare for the forecasted weather event), together with hyperlink(s) to make online purchase(s) of recommended product(s) 120 and/or other information about the availability of recommended product(s) to be purchased in physical venue(s) that are within a predetermined threshold distance from user location 110.

In response to the user purchasing any of the recommended product(s) 120 or other product(s) via the online portal of the website, product purchase recommendation system 104 receives actual purchase data 122 from the website. Actual purchase data 122 includes the details of the products purchased by the user. Product purchase recommendation system 104 stores the actual purchase data 122 as additional crowdsourced product purchase data 112 in the corpus of knowledge database in data repository 106. In a subsequent iteration of determining recommended product(s) to purchase to prepare for the weather event, product purchase recommendation system 104 uses actual purchase data 122 and other purchase data to generate and present a subsequent updated version of recommended product(s) 120 to another user who is using the aforementioned online portal or another online portal of another business specified in scope definition 108, where the updated version can be different from the initial recommended product(s) 120.

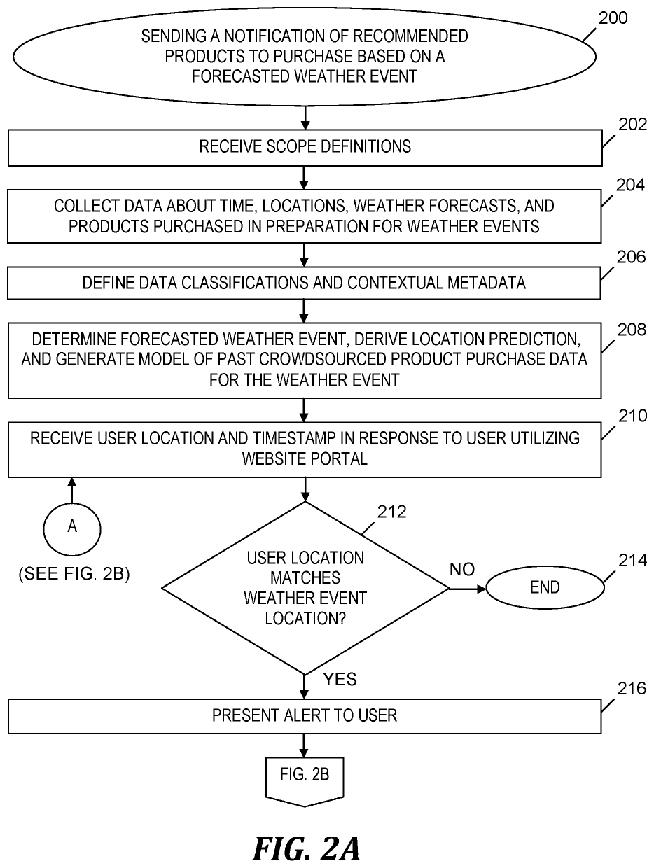

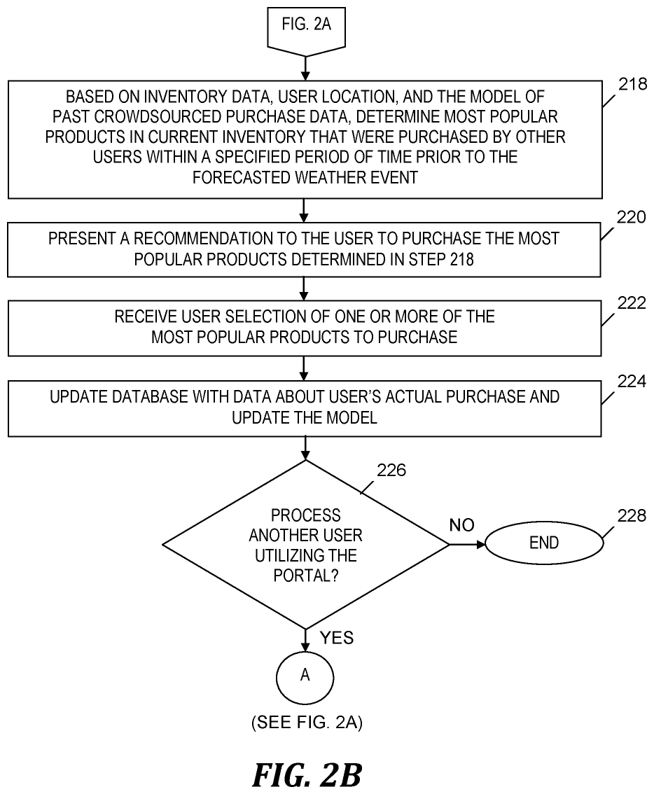

The functionality of the components shown in FIG. 1 is described in more detail in the discussion of FIGS. 2A-2B, FIG. 3, and FIG. 4 presented below.

### Process For Sending a Notification of Recommended Product(s) to Purchase in Preparation For a Weather Event

FIGS. 2A-2B depict a flowchart of a process of sending a notification of one or more recommended products to purchase in preparation for a weather event, where the process is implemented in the system of FIG. 1, in accordance with embodiments of the present invention. The process of FIGS. 2A-2B starts at step 200 in FIG. 2A. In step 202, product purchase recommendation system 104 (see FIG. 1) receives scope definition 108 (see FIG. 1).

In step 204, product purchase recommendation system 104 (see FIG. 1) collects weather data 114 (see FIG. 1) about a forecasted weather event and crowdsourced product purchase data 112 (see FIG. 1), which specifies products purchased in preparation for the forecasted weather event or other weather events, timestamps indicating when the product purchases were made, and geographic locations of the users at the time the users made the product purchases via online portals of shopping web sites. After collecting the data in step 204, product purchase recommendation system 104 (see FIG. 1) stores the collected data in the corpus of knowledge database in data repository 106 (see FIG. 1).

In step 206, product purchase recommendation system 104 (see FIG. 1) defines data classifications 118 (see FIG. 1) and contextual metadata, including event name, event tagging, and event filtering.

In step 208, product purchase recommendation system 104 (see FIG. 1) determines a forecasted weather event from weather data 114 (see FIG. 1), derives a prediction of the geographic location(s) of the forecasted weather event for one or more particular dates and times, and generates a model of past crowdsourced product purchase data indicating what products were purchased and when those products were purchased in preparation for the forecasted weather event and/or for other past weather events whose types match the type of the forecasted weather event. The forecasted weather event can have multiple geographic locations based on the weather event being predicted to move to different locations, and these geographic locations can change over time as the weather event forecast is updated.

In one embodiment, product purchase recommendation system 104 (see FIG. 1) in step 208 receives predicted attributes of the forecasted weather event, including the type of the weather event and the predicted severity and duration of the weather event.

Prior to step 210, a triggering event occurs by which a user logs into or otherwise starts using an online portal of a website of one of the businesses specified in scope definition 108 (see FIG. 1). In step 210, in response to the aforementioned triggering event, product purchase recommendation system 104 (see FIG. 1) receives user location 110 (see FIG. 1) and a timestamp of the current date and time. In one embodiment, the online portal queries the user for permission to use the current location of the user. In one embodiment, product purchase recommendation system 104 (see FIG. 1) receives multiple locations in user location 110 (see FIG. 1), where the user is planning to be in the multiple locations during the time period specified in scope definition 108. For example, the user is planning to travel and provides a second location in addition to the user's current location, where the user is planning to travel to the second location within two days and a forecasted hurricane is predicted to affect the second location five days after the current day.

In step 212, product purchase recommendation system 104 (see FIG. 1) determines whether user location 110 (see FIG. 1) matches the predicted geographic location of the forecasted weather event. If product purchase recommendation system 104 (see FIG. 1) determines in step 212 that user location 110 (see FIG. 1) does not match the predicted geographic location of the forecasted weather event, then the No branch of step 212 is taken and the process of FIGS. 2A-2B ends at step 214.

If product purchase recommendation system 104 (see FIG. 1) determines in step 212 that user location 110 (see FIG. 1) matches the predicted geographic location of the forecasted weather event, then the Yes branch of step 212 is taken and step 216 is performed.

In step 216, product purchase recommendation system 104 (see FIG. 1) presents an alert to the user via the online portal, where the alert notifies the user about the forecasted weather event and the predication that the weather event is predicted to affect the geographic location of the user. Following step 216, the process of FIGS. 2A-2B continues with step 218 in FIG. 2B.

Prior to step 218, product purchase recommendation system 104 (see FIG. 1) receives inventory data 116 (see FIG. 1) from the shopping website whose online portal is being utilized by the user. In step 218, based on inventory data 116 (see FIG. 1), user location 110 (see FIG. 1), and the model generated in step 208 (see FIG. 2A), product purchase recommendation system 104 (see FIG. 1) determines the most popular products (i.e., most frequently purchased products) that were purchased by other users within the time period specified in scope definition 108 (see FIG. 1) which is prior to the predicted dates and times when the forecasted weather event is expected to start affecting the geographic locations of the other users. The determination of the most popular products is limited to products that are included in a current inventory of the website or a current inventory of a physical venue of the business. In one embodiment, each of the geographic locations of the other users is the same as user location 110 (see FIG. 1) and product purchase recommendation system 104 (see FIG. 1) determines the most popular products from crowdsourced product purchase data about products purchased in preparation for the forecasted weather event, without requiring historical data about purchases of products made in preparation for one or more other weather events that preceded the forecasted weather event. By using the crowdsourced product purchase data, product purchase recommendation system 104 (see FIG. 1) can determine that a new product is one of the most popular products, where the new product has recently been initially made available for purchase and therefore had not been available for purchase in preparation for other, past weather event(s) of the same type as the forecasted weather event.

In another embodiment, the geographic locations of the other users include both first geographic location(s) that are the same as user location 110 (see FIG. 1) and second geographic location(s) that are different from user location 110 (see FIG. 1).

In an alternate embodiment, product purchase recommendation system 104 (see FIG. 1) determines the aforementioned most popular products and another group of most popular products that had been purchased by users who were located in the same geographic location as user location 110 (see FIG. 1) (e.g., the users were located in the same ZIP code as the aforementioned user) and had been purchased in preparation for one or more other weather events that occurred in the past, where attributes of the one or more other weather events match attributes of the forecasted weather event (e.g., the type of each of the one or more other weather events matches the type of the forecasted weather event, or the type, severity, and duration of each of the one or more other weather events match the type, forecasted severity, and forecasted duration, respectively, of the forecasted weather event).

In step 220, product purchase recommendation system 104 (see FIG. 1) presents recommended product(s) 120 (see FIG. 1) to the user via the online portal, which are product(s) that are included in the most popular products determined in step 218 and that are recommended to be purchased to prepare for the forecasted weather event. In one embodiment, product purchase recommendation system 104 (see FIG. 1) presents recommended product(s) 120 (see FIG. 1) to the user as product(s) that were purchased by other users located in the same geographic location as the user and purchased in preparation for the forecasted weather event.

In one embodiment, product purchase recommendation system 104 (see FIG. 1) in step 220 presents first and second lists of product(s) included in recommended product(s) 120 (see FIG. 1). The first list of product(s) are product(s) purchased by a first group of other users in preparation for the forecasted weather event, where the first group of other users are located in the same geographic location as the user (e.g., same ZIP code as the ZIP code of the location of the user). The second list of product(s) are product(s) purchased by a second group of other users in preparation for the forecasted weather event, where the second group of other users are located in geographic locations that are different from the location of the user. In one embodiment, product purchase recommendation system 104 (see FIG. 1) prioritizes the first list of product(s) over the second list of product(s) by displaying the first list in a position that is more prominent that the position of the second list (e.g., the first list is displayed before or above the second list), or by utilizing graphical display elements to visually emphasize the first list over the second list (e.g., display the product(s) in the first list in boldface and display the product(s) in the second list in regular typeface, without boldface).

In one embodiment, product purchase recommendation system 104 (see FIG. 1) determines an inventory of a product available for purchase in a given physical venue in a proximity to user location 110 (see FIG. 1), where the product is included in the most popular products determined in step 218. Product purchase recommendation system 104 (see FIG. 1) in step 220 sends to the user a recommendation to purchase the product via the online portal or in the given physical venue based in part on user location 110 (see FIG. 1) and a number of users whose purchases of the product can be satisfied by the inventory of the product in the given physical venue.

In step 222, product purchase recommendation system 104 (see FIG. 1) receives the user's selection of at least one of the recommended product(s) 120 (see FIG. 1) to purchase to prepare for the forecasted weather event.

In step 224, product purchase recommendation system 104 (see FIG. 1) updates the corpus of knowledge database with data about the user's actual purchase of at least one of the recommended product(s) 120 (see FIG. 1) and updates the model initially generated in step 208 (see FIG. 2A).

In step 226, product purchase recommendation system 104 (see FIG. 1) determines whether processing needs to begin for another user who is utilizing an online portal of a web site of one of the businesses specified in scope definition 108 (see FIG. 1). If product purchase recommendation system 104 (see FIG. 1) determines in step 226 that processing of another user does not need to begin, then the No branch of step 226 is taken and the process of FIGS. 2A-2B ends at step 228.

If product purchase recommendation system 104 (see FIG. 1) determines in step 226 that another user is utilizing one of the aforementioned online portals, then the Yes branch of step 226 is taken and the process of FIGS. 2A-2B loops back to step 210 in FIG. 2A to iteratively process the other user.

In one embodiment, the user makes an actual purchase of one of the recommended product(s) 120 (see FIG. 1) in response to receiving the recommendation presented in step 220. Based in part on the recommended product(s) 120 (see FIG. 1), the recommendation presented in step 220, the actual purchase of the product by the user, and a number of users who purchased the product in preparation for one or more past weather events whose attributes match attributes of the forecasted weather event, product purchase recommendation system 104 (see FIG. 1) determines that a supply of the product in an area that includes user location 110 (see FIG. 1) is less than an amount needed to satisfy a group of users in the area. In response to determining that the supply of the product in the area is less than the amount needed to satisfy the group of users in the area, product purchase recommendation system 104 (see FIG. 1) sends one or more notifications to first one or more physical venues of a business that are outside of the area, within a threshold distance of the area, and not in any area that is predicted to be affected by the forecasted weather event. The one or more notifications request a transfer of the product from the first one or more physical venues to second one or more physical venues of one or more businesses that are within the area. By sending the aforementioned one or more notifications, product purchase recommendation system 104 (see FIG. 1) initiates a redistribution of the product to improve the availability of the product to customers who need the product to prepare for the forecasted weather event.

In one embodiment, product purchase recommendation system 104 (see FIG. 1) receives a first time period that is prior to the forecasted weather event and determining the most popular products in step 218 includes determining the products that were purchased in the first time period. Product purchase recommendation system 104 (see FIG. 1) receives a second time period that is prior to the forecasted weather event, where the second time period is different from the first time period. Product purchase recommendation system 104 (see FIG. 1) determines other products purchased by a second group of other users in preparation for the forecasted weather event, where the second group of other users are located in one or more locations other than user location 110 (see FIG. 1) and the other products are purchased within the second time period. Based in part on the other products purchased by the second group of other users in preparation for the forecasted weather event, product purchase recommendation system 104 (see FIG. 1) identifies a second group of one or more products that were more popular to purchase by the second group of other users during the second time period than any other product purchased by the second group of other users during the second time period. The second group of one or more products are different from the most popular products determined in step 218 based on the first and second time periods being different.

### EXAMPLE

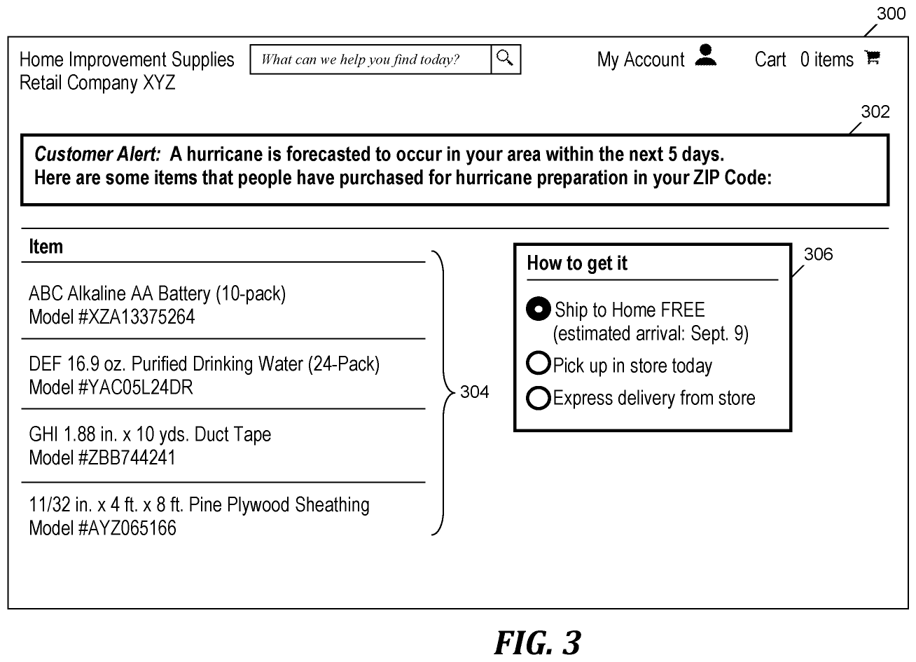

FIG. 3 is an example of a notification of recommended products to purchase in preparation for a hurricane, where the notification is sent in the process of FIGS. 2A-2B, in accordance with embodiments of the present invention. A user logs into an online portal of a website of a home improvement supplies retail company and allows the website to determine and use the ZIP code of the user, which is an example of user location 110 (see FIG. 1). The website determines the current date and time and presents to the user a screen display 300 which includes a notification 302. An alert is included in notification 302 which informs the user about an impending hurricane that is forecasted to occur in user location 110 (see FIG. 1) within the next five days, and is presented to the user as a result of step 216 (see FIG. 2A).

Notification 302 also includes a recommendation to purchase products that other people have purchased for hurricane preparation, where the other people are located in the same ZIP code as the user, and where the recommended products are listed below notification 302 in a list of items 304. Batteries, drinking water, duct tape, and plywood sheets are included in list of items 304. List of items 304 is an example of the most popular products, which are presented to the user as a result of step 220 (see FIG. 2B). Screen display 300 also includes onscreen radio buttons 306 which indicate methods of delivering a purchased product.

### Computer System

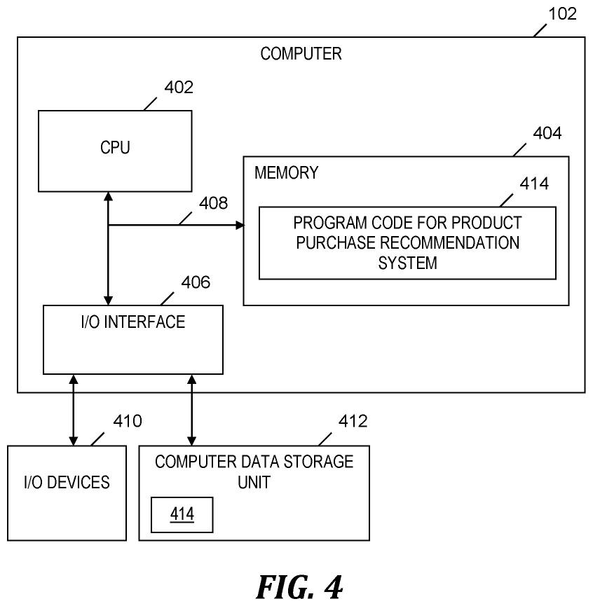

FIG. 4 is a block diagram of a computer included in the system of FIG. 1 and that implements the process of FIGS. 2A-2B, in accordance with embodiments of the present invention. Computer 102 is a computer system that generally includes a central processing unit (CPU) 402, a memory 404, an input/output (I/O) interface 406, and a bus 408. Further, computer 102 is coupled to I/O devices 410 and a computer data storage unit 412. CPU 402 performs computation and control functions of computer 102, including executing instructions included in program code 414 for a system that includes product purchase recommendation system 104 (see FIG. 1) to perform a method of sending a notification of recommended products to purchase based on a forecasted weather event, where the instructions are executed by CPU 402 via memory 404. CPU 402 may include a single processing unit, or be distributed across one or more processing units in one or more locations (e.g., on a client and server).

Memory 404 includes a known computer readable storage medium, which is described below. In one embodiment, cache memory elements of memory 404 provide temporary storage of at least some program code (e.g., program code 414) in order to reduce the number of times code must be retrieved from bulk storage while instructions of the program code are executed. Moreover, similar to CPU 402, memory 404 may reside at a single physical location, including one or more types of data storage, or be distributed across a plurality of physical systems in various forms. Further, memory 404 can include data distributed across, for example, a local area network (LAN) or a wide area network (WAN).

I/O interface 406 includes any system for exchanging information to or from an external source. I/O devices 410 include any known type of external device, including a display, keyboard, etc. Bus 408 provides a communication link between each of the components in computer 102, and may include any type of transmission link, including electrical, optical, wireless, etc.

I/O interface 406 also allows computer 102 to store information (e.g., data or program instructions such as program code 414) on and retrieve the information from computer data storage unit 412 or another computer data storage unit (not shown). Computer data storage unit 412 includes a known computer-readable storage medium, which is described below. In one embodiment, computer data storage unit 412 is a non-volatile data storage device, such as a magnetic disk drive (i.e., hard disk drive) or an optical disc drive (e.g., a CD-ROM drive which receives a CD-ROM disk).

Memory 404 and/or storage unit 412 may store computer program code 414 that includes instructions that are executed by CPU 402 via memory 404 to send a notification of recommended products to purchase based on a forecasted weather event. Although FIG. 4 depicts memory 404 as including program code, the present invention contemplates embodiments in which memory 404 does not include all of code 414 simultaneously, but instead at one time includes only a portion of code 414.

Further, memory 404 may include an operating system (not shown) and may include other systems not shown in FIG. 4.

In one embodiment, computer data storage unit 412 includes data repository 106 (see FIG. 1).

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to sending a notification of recommended products to purchase based on a forecasted weather event. Thus, an embodiment of the present invention discloses a process for supporting computer infrastructure, where the process includes providing at least one support service for at least one of integrating, hosting, maintaining and deploying computer-readable code (e.g., program code 414) in a computer system (e.g., computer 102) including one or more processors (e.g., CPU 402), wherein the processor(s) carry out instructions contained in the code causing the computer system to send a notification of recommended products to purchase based on a forecasted weather event. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of sending a notification of recommended products to purchase based on a forecasted weather event.

While it is understood that program code 414 for sending a notification of recommended products to purchase based on a forecasted weather event may be deployed by manually loading directly in client, server and proxy computers (not shown) via loading a computer-readable storage medium (e.g., computer data storage unit 412), program code 414 may also be automatically or semi-automatically deployed into computer 102 by sending program code 414 to a central server or a group of central servers. Program code 414 is then downloaded into client computers (e.g., computer 102) that will execute program code 414. Alternatively, program code 414 is sent directly to the client computer via e-mail. Program code 414 is then either detached to a directory on the client computer or loaded into a directory on the client computer by a button on the e-mail that executes a program that detaches program code 414 into a directory. Another alternative is to send program code 414 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 414 is transmitted to the proxy server and then it is stored on the proxy server.

Another embodiment of the invention provides a method that performs the process steps on a subscription, advertising and/or fee basis. That is, a service provider can offer to create, maintain, support, etc. a process of sending a notification of recommended products to purchase based on a forecasted weather event. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product at any possible technical detail level of integration. The computer program product may include a computer readable storage medium (or media) (i.e., memory 404 and computer data storage unit 412) having computer readable program instructions 414 thereon for causing a processor (e.g., CPU 402) to carry out aspects of the present invention.

The computer readable storage medium can be a tangible device that can retain and store instructions (e.g., program code 414) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 414) described herein can be downloaded to respective computing/processing devices (e.g., computer 102) from a computer readable storage medium or to an external computer or external storage device (e.g., computer data storage unit 412) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 414) for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIGS. 2A-2B) and/or block diagrams (e.g., FIG. 1 and FIG. 4) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 414).

These computer readable program instructions may be provided to a processor (e.g., CPU 402) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 412) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 414) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of sending a notification of one or more recommended products to purchase in preparation for a weather event, the method comprising the steps of:
a computer determining a location of a user in response to a determination that the user is utilizing an online portal for a shopping website;
the computer determining that a weather event is forecasted to affect one or more locations;
the computer determining that the location of the user is included in the one or more locations which are forecasted to be affected by the weather event;
the computer determining products purchased by other users in preparation for the weather event, the other users being located in the one or more locations and the products being purchased during a predetermined time period prior to the weather event;
based on the location of the user being included in the one or more locations forecasted to be affected by the weather event and the products purchased by the other users in preparation for the weather event, the computer identifying one or more products that were more popular to purchase by the other users during the predetermined time period than any other product purchased by the other users during the predetermined time period; and
the computer sending a notification to the user via the online portal that recommends that the user purchase the identified one or more products to prepare for the weather event.

2. The method of claim 1, further comprising the computer determining that the other users are located in the location of the user, wherein the step of identifying the one or more products is based on the other users being located in the location of the user, and wherein the step of sending the notification includes notifying the user that the identified one or more products were purchased by the other users in preparation for the weather event in the location of the user.

3. The method of claim 1, further comprising the step of the computer determining that a first portion of the other users is located in the location of the user and a second portion of the other users is located in one or more other locations that are forecasted to be affected by the weather event,
wherein the step of identifying the one or more products includes identifying first one or more products based on the first portion of the other users being located in the location of the user and identifying second one or more products based on the second portion of the other users being located in the one or more other locations, and
wherein the step of sending the notification includes presenting the first one or more products in a first list and presenting the second one or more products in a second list, the first and second lists being presented separately via the online portal.

4. The method of claim 1, wherein the step of identifying the one or more products includes identifying a product (i) by utilizing crowdsourced data about the product being purchased by the other users prior to the user utilizing the online portal and purchased in preparation for the weather event and (ii) without requiring historical data about purchases of product made in preparation for one or more other weather events that preceded the weather event.

5. The method of claim 4, wherein the step of identifying the product includes identifying a new product that had not been available for purchase in preparation for the one or more other weather events.

6. The method of claim 1, further comprising the steps of:
the computer determining an inventory of a product available for purchase in a given physical venue in a proximity to the location of the user, the product being included in the identified one or more products; and
the computer sending to the user a recommendation to purchase the product via the online portal or in the given physical venue based in part on the location of the user and a number of users whose purchases of the product can be satisfied by the inventory of the product in the given physical venue.

7. The method of claim 1, further comprising the steps of:
the computer determining that the user, in response to the notification, made an actual purchase of a product included in the identified one or more products;
based in part on the identified one or more products, the notification sent to the user that recommends the user purchase the identified one or more products, the actual purchase of the product by the user, and a number of users who purchased the product in preparation for one or more other past weather events whose attributes match attributes of the weather event, the computer determining that a supply of the product in an area that includes the location of the user is less than an amount to satisfy a group of users in the area; and
in response to the step of determining that the supply of the product is less than the amount to satisfy the group of users, the computer sending one or more notifications to first one or more physical venues outside of the area and within a threshold distance of the area, the one or more notifications requesting a transfer of the product to a second one or more physical venues within the area.

8. The method of claim 1, further comprising the steps of:
the computer receiving a first time period prior to the weather event, wherein the step of determining the products purchased by the other users in preparation for the weather event includes determining the products purchased within the first time period;
the computer receiving a second time period prior to the weather event, the second time period being different from the first time period;
the computer determining other products purchased by second other users in preparation for the weather event, the second other users being located in the one or more locations and the other products being purchased within the second time period;
based in part on the other products purchased by the second other users in preparation for the weather event, the computer identifying second one or more products that were more popular to purchase by the second other users during the second time period than any other product purchased by the second other users during the second time period, wherein the second one or more products are different from the one or more products based on the second time period being different from the first time period.

9. The method of claim 1, further comprising the step of:
providing at least one support service for at least one of creating, integrating, hosting, maintaining, and deploying computer readable program code in the computer, the program code being executed by a processor of the computer to implement the steps of determining the location of the user, determining that the weather event is forecasted to affect the one or more locations, determining that the location of the user is included in the one or more locations, determining the products purchased by the other users, identifying the one or more products, and sending the notification.

10. A computer program product for sending a notification of one or more recommended products to purchase in preparation for a weather event, the computer program product comprising a computer readable storage medium having computer readable program code stored on the computer readable storage medium, wherein the computer readable storage medium is not a transitory signal per se, the computer readable program code being executed by a central processing unit (CPU) of a computer system to cause the computer system to perform a method comprising the steps of:
the computer system determining a location of a user in response to a determination that the user is utilizing an online portal for a shopping web site;
the computer system determining that a weather event is forecasted to affect one or more locations;
the computer system determining that the location of the user is included in the one or more locations which are forecasted to be affected by the weather event;
the computer system determining products purchased by other users in preparation for the weather event, the other users being located in the one or more locations and the products being purchased during a predetermined time period prior to the weather event;
based on the location of the user being included in the one or more locations forecasted to be affected by the weather event and the products purchased by the other users in preparation for the weather event, the computer system identifying one or more products that were more popular to purchase by the other users during the predetermined time period than any other product purchased by the other users during the predetermined time period; and
the computer system sending a notification to the user via the online portal that recommends that the user purchase the identified one or more products to prepare for the weather event.

11. The computer program product of claim 10, wherein the method further comprises the computer system determining that the other users are located in the location of the user, wherein the step of identifying the one or more products is based on the other users being located in the location of the user, and wherein the step of sending the notification includes notifying the user that the identified one or more products were purchased by the other users in preparation for the weather event in the location of the user.

12. The computer program product of claim 10, wherein the method further comprises the step of the computer system determining that a first portion of the other users is located in the location of the user and a second portion of the other users is located in one or more other locations that are forecasted to be affected by the weather event,
wherein the step of identifying the one or more products includes identifying first one or more products based on the first portion of the other users being located in the location of the user and identifying second one or more products based on the second portion of the other users being located in the one or more other locations, and
wherein the step of sending the notification includes presenting the first one or more products in a first list and presenting the second one or more products in a second list, the first and second lists being presented separately via the online portal.

13. The computer program product of claim 10, wherein the step of identifying the one or more products includes identifying a product (i) by utilizing crowdsourced data about the product being purchased by the other users prior to the user utilizing the online portal and purchased in preparation for the weather event and (ii) without requiring historical data about purchases of product made in preparation for one or more other weather events that preceded the weather event.

14. The computer program product of claim 13, wherein the step of identifying the product includes identifying a new product that had not been available for purchase in preparation for the one or more other weather events.

15. The computer program product of claim 10, wherein the method further comprises the steps of:
the computer system determining an inventory of a product available for purchase in a given physical venue in a proximity to the location of the user, the product being included in the identified one or more products; and
the computer system sending to the user a recommendation to purchase the product via the online portal or in the given physical venue based in part on the location of the user and a number of users whose purchases of the product can be satisfied by the inventory of the product in the given physical venue.

16. A computer system comprising:
a central processing unit (CPU);
a memory coupled to the CPU; and
a computer readable storage device coupled to the CPU, the computer readable storage device containing instructions that are executed by the CPU via the memory to implement a method of sending a notification of one or more recommended products to purchase in preparation for a weather event, the method comprising the steps of:
the computer system determining a location of a user in response to a determination that the user is utilizing an online portal for a shopping website;
the computer system determining that a weather event is forecasted to affect one or more locations;
the computer system determining that the location of the user is included in the one or more locations which are forecasted to be affected by the weather event;
the computer system determining products purchased by other users in preparation for the weather event, the other users being located in the one or more locations and the products being purchased during a predetermined time period prior to the weather event;
based on the location of the user being included in the one or more locations forecasted to be affected by the weather event and the products purchased by the other users in preparation for the weather event, the computer system identifying one or more products that were more popular to purchase by the other users during the predetermined time period than any other product purchased by the other users during the predetermined time period; and
the computer system sending a notification to the user via the online portal that recommends that the user purchase the identified one or more products to prepare for the weather event.

17. The computer system of claim 16, wherein the method further comprises the computer system determining that the other users are located in the location of the user, wherein the step of identifying the one or more products is based on the other users being located in the location of the user, and wherein the step of sending the notification includes notifying the user that the identified one or more products were purchased by the other users in preparation for the weather event in the location of the user.

18. The computer system of claim 16, wherein the method further comprises the step of the computer system determining that a first portion of the other users is located in the location of the user and a second portion of the other users is located in one or more other locations that are forecasted to be affected by the weather event,
wherein the step of identifying the one or more products includes identifying first one or more products based on the first portion of the other users being located in the location of the user and identifying second one or more products based on the second portion of the other users being located in the one or more other locations, and
wherein the step of sending the notification includes presenting the first one or more products in a first list and presenting the second one or more products in a second list, the first and second lists being presented separately via the online portal.

19. The computer system of claim 16, wherein the step of identifying the one or more products includes identifying a product (i) by utilizing crowdsourced data about the product being purchased by the other users prior to the user utilizing the online portal and purchased in preparation for the weather event and (ii) without requiring historical data about purchases of product made in preparation for one or more other weather events that preceded the weather event.

20. The computer system of claim 19, wherein the step of identifying the product includes identifying a new product that had not been available for purchase in preparation for the one or more other weather events.
